(19) United States
(12) Patent Application Publication
(10) Pub. No.: US 2026/0272740 A1
(43) Pub. Date: Sep. 17, 2026

(54) LIFT AND TILT DEVICE FOR A POWER WHEELCHAIR

(71) Applicant: PERMOBIL AB, Sundsvall (SE)

(72) Inventors: Jonas JÄHKEL, Stockholm (SE); Håkan BERGMAN, Timrå (SE)

(21) Appl. No.: 19/166,739

(22) PCT Filed: Mar. 21, 2024
(86) PCT No.: PCT/EP2024/057662

§ 371 Date: Sep. 18, 2025

(30) Foreign Application Priority Data
Mar. 21, 2023 (EP) 23163175.5

(51) Int. Cl. A61G 5/10

(52) U.S. Cl. CPC A61G 5/1059; A61G 5/1075

(57) ABSTRACT

A lift and tilt device (1) for manoeuvring a seat of a power wheelchair, comprising: an upper beam (3) having a proximal end (3a) and a distal end (3b), a first linear actuator arranged along the upper beam (3) comprising a first carrier unit configured to run along the upper beam (3) from a distal position towards the proximal end (3a) to a proximal position, and from the proximal position to the distal position, a lower beam (5), a second linear actuator arranged along the lower beam (5) comprising a second carrier unit configured to run along the lower beam (5) between a first position and a second position, a main arm (7) pivotally connected to the proximal end (3a) of the upper beam (3) and to the second carrier unit, an upper arm (9) pivotally connected to the main arm (7) and to the first carrier unit, a mounting structure (13) fixedly arranged relative to the lower beam (5), and a lower arm (11) pivotally connected to the main arm (7) and to the mounting structure (13).

### TECHNICAL FIELD

The present disclosure generally relates to power wheelchairs.

### BACKGROUND

Power wheelchairs may be provided with lift and tilt functionality to enable a user to obtain a tilted or a lifted/elevated position in the seat.

An example of a lift and tilt device for a power wheelchair is disclosed in EP2823796. The electric wheelchair comprises a chassis, a lift device having a base member which is fixedly arranged to the chassis, and a lifting member arranged to move rectilinearly relative to the base member along an axis defined by a longitudinal extension of the lifting member, a tilt frame, a first arm pivotally coupled to the lifting member and the tilt frame, and a second arm coupled to the base member. The second arm is pivotally coupled to the first arm forming a pivot connection, wherein movement of the lifting member towards the extended position moves the pivot connection towards the base member and movement of the lifting member towards the retracted position moves the pivot connection away from the base member.

### SUMMARY

Due to the vertical orientation of the base member and lifting member of the lift device disclosed in EP2823796, either the seat to floor height will be rather high if the lift capability is to be good, or the lift capability will suffer if the seat to floor height is to be low. In this latter case, the tilt angle will also become lower.

A general object of the present disclosure is to provide a lift and tilt device for a power wheelchair which solves or at least mitigates the problems of the prior art.

There is hence according to a first aspect of the present disclosure provided a lift and tilt device for manoeuvring a seat of a power wheelchair, comprising: an upper beam having a proximal end and a distal end, a first linear actuator arranged along the upper beam comprising a first carrier unit configured to run along the upper beam from a distal position towards the proximal end to a proximal position, and from the proximal position to the distal position, a lower beam, a second linear actuator arranged along the lower beam comprising a second carrier unit configured to run along the lower beam between a first position and a second position, a main arm pivotally connected to the proximal end of the upper beam and to the second carrier unit, an upper arm pivotally connected to the main arm and to the first carrier unit, a mounting structure fixedly arranged relative to the lower beam, and a lower arm pivotally connected to the main arm and to the mounting structure.

Because of the two linear actuators arranged along the respective beam, and the main, upper, and lower arm configuration, a lift and tilt device which is able to provide a low seat to floor height irrespective of the lifting capability is achieved. It is thus, for example, possible to provide both a low minimum seat to floor height and a high maximum seat to floor height.

According to one embodiment when the first carrier unit is in the distal position and the second carrier unit is in the first position, the lift and tilt device is in a folded state.

According to one embodiment in the folded state, the upper beam is arranged in parallel with the lower beam.

According to one embodiment when the first carrier unit is located closer to the proximal position than in the folded state and the second carrier unit is closer to the second position than in the folded state, the lift and tilt device is in a lifted state.

According to one embodiment in the lifted state the upper beam is parallel with the lower beam.

According to one embodiment the mounting structure is connected to a second end of the lower beam, wherein the second carrier unit is configured to run along the lower beam from the first position towards the second end to reach the second position.

According to one embodiment when the first carrier unit is in the distal position and the second carrier unit is in the second position, the lift and tilt device is in a tilted state.

One embodiment comprises a first electric motor configured to drive the first linear actuator, and a second electric motor configured to drive the second linear actuator.

According to one embodiment the lower beam is configured to be immovably attached to a chassis of a power wheelchair.

According to one embodiment the upper beam and the lower beam are contained in a median plane of the lift and tilt device.

According to one embodiment, in cross-section each of the first and the second carrier unit comprises a plurality of protrusions along their perimeter, and wherein each of the upper and lower beam has a plurality of planar support surfaces configured to support a respective one of the protrusions of one of the first and the second carrier units, and a plurality of sliding bearings, each sliding bearing being arranged between a respective protrusion and support surface to facilitate axial movement of the first and second carrier unit relative to the respective beam.

According to one embodiment, for each of the first and the second carrier unit the protrusions are two upper lateral protrusions and two lower lateral protrusions, and each of the upper and lower beam has four planar support surfaces configured to support a respective one of the lateral protrusions.

Due to the planar support surfaces, the fit between the upper/lower beams and the first/second carrier units will be less dependent on tolerances, and axial movement between these components is therefore facilitated.

The bearings may be composed of a polymeric material.

The sliding bearings may be fixedly attached to the respective first and second carrier unit.

According to one embodiment each support surface forms part of a respective groove in the upper and lower beam, in which the respective lateral protrusion is configured to run.

According to one embodiment each of the first and the second carrier unit comprises a central carrier unit body, and two lateral wing members, wherein each lateral wing member is attached to a respective side of the central carrier unit body.

According to one embodiment each lateral wing member comprises an upper protrusion and a lower protrusion, and wherein a profiled inner surface of the upper beam and the lower beam comprises a plurality of shoulders, each shoulder being arranged to guide a respective one of the upper protrusion and the lower protrusion.

One embodiment comprises sliding bearings, each sliding bearing being provided between a respective shoulder and one of the upper or lower protrusions.

According to one embodiment the upper beam has at least one open slot to enable the pivot connection between the first carrier unit and the upper arm, and the lower beam has at least one open slot to enable the pivot connection between the second carrier unit and the main arm.

According to one embodiment the upper beam comprises at least one flexible curtain arranged to cover a respective one of the at least one open slot of the upper beam, and the lower beam comprises at least one flexible curtain arranged to cover a respective one of the at least one open slot of the lower beam.

The interior of the upper and lower beam can thus be protected from dirt. For example, the first and second linear actuators may be protected from dirt.

According to one embodiment each curtain is composed of silicone.

According to one embodiment the first linear actuator is a first screw type actuator comprising a first rotatable screw, wherein the first carrier unit is configured to run along the upper beam, wherein the second linear actuator is a second screw type actuator comprising a second rotatable screw, and wherein the second carrier unit is configured to run along the lower beam.

The first screw type actuator may for example be a lead screw actuator or a ball screw actuator.

The second screw type actuator may for example be a lead screw actuator or a ball screw actuator.

The first linear actuator could alternatively be hydraulic actuator or a pneumatic actuator.

The second linear actuator could alternatively be hydraulic actuator or a pneumatic actuator.

According to one embodiment the first linear actuator is arranged inside the upper beam, and the second linear actuator is arranged inside the lower beam.

According to one embodiment each of the upper beam and the lower beam has one of the following structures: is made in one piece and has a rectangular cross-sectional shape, is formed of two U-beams facing each other, or is formed of one U-beam.

There is according to a second aspect of the present disclosure provided a power wheelchair comprising the lift and tilt device of the first aspect.

One embodiment comprises a wheelchair chassis, wherein the mounting structure is integrated with the wheelchair chassis, or is mounted to the wheelchair chassis, and wherein the lower beam is integrated with the wheelchair chassis or is mounted to a top side of the wheelchair chassis.

According to one example the upper beam and the lower beam are contained in a median plane of the power wheelchair.

According to one example at least one of the upper beam and the lower beam is contained in a median plane of the power wheelchair.

According to one example the upper beam and the lower beam are arranged at a respective side of a median plane of the power wheelchair.

The power wheelchair may according to one example comprise a plurality of lift and tilt devices of the first aspect, such as two lift and tilt devices of the first aspect. The two lift and tilt devices may be arranged symmetrically with respect to the median plane of the power wheelchair, i.e., one at each side of the median plane at the same distance from the median plane. The plurality of lift and tilt devices may be configured to be operated in parallel with each other.

There is according to a third aspect of the present disclosure provided a beam structure for a lift and tilt device of a power wheelchair, the beam structure comprising: a beam, a linear actuator arranged inside the beam and comprising a carrier unit, the carrier unit being configured to run along the beam, wherein in cross-section, the carrier unit comprises a plurality of protrusions along its perimeter, wherein the beam has a corresponding number of planar support surfaces configured to support a respective one of the protrusions, and a plurality of sliding bearings, each sliding bearing being arranged between a respective protrusion and support surface to facilitate axial movement of the first and the second carrier unit relative to the respective beam.

Each support surface may form part of a respective groove in the beam, in which the respective protrusion is configured to run.

The protrusions may, in cross-section, be distributed along a circumferential or tangential direction of the carrier unit, along its outer perimeter.

According to one example for each beam, the protrusions may comprise two upper lateral protrusions and two lower lateral protrusions, and wherein the beam has four planar support surfaces configured to support a respective one of the lateral protrusions.

The beam may be an upper beam or a lower beam of the lift and tilt device.

The beam may have at least one open slot for connecting the carrier unit to an arm, such as an upper arm or a main arm.

The beam may comprise a flexible curtain arranged to cover the at least one open slot.

The curtain may comprise an upper and a lower curtain member extending in parallel along the open slot, the upper and the lower curtain members contacting each other and being arranged to close the open slot.

The curtain may for example be composed of silicone.

The linear actuator may be a screw type actuator comprising a rotatable screw, wherein the carrier unit is configured to run along the rotatable screw. There is according to a fourth aspect of the present disclosure provided a lift and tilt device for manoeuvring a seat of a power wheelchair, comprising: a lower beam, a linear actuator arranged along the lower beam comprising a carrier unit configured to run along the lower beam between a first position and a second position, a main arm pivotally connected to the carrier unit, a mounting structure fixedly arranged relative to the lower beam, and a lower arm pivotally connected to the main arm and to the mounting structure.

One embodiment comprises an electric motor configured to drive the linear actuator.

According to one embodiment the lower beam is configured to be immovably attached to a chassis of a power wheelchair.

According to one embodiment the lower beam is contained in a median plane of the lift and tilt device.

According to one embodiment in cross-section the carrier unit comprises a plurality of protrusions along their perimeter, and wherein the lower beam has a plurality of planar support surfaces configured to support a respective one of the protrusions of the carrier units, and a plurality of sliding bearings, each sliding bearing being arranged between a respective protrusion and support surface to facilitate axial movement of the carrier unit relative to the lower beam.

According to one embodiment the protrusions are two upper lateral protrusions and two lower lateral protrusions, and wherein the lower beam has four planar support surfaces configured to support a respective one of the lateral protrusions.

According to one embodiment each support surface forms part of a respective groove in the lower beam, in which the respective lateral protrusion is configured to run.

According to one embodiment the carrier unit comprises a carrier unit body, and two lateral wing members, wherein each lateral wing member is attached to a respective side of the carrier unit body.

According to one embodiment each lateral wing member comprises an upper protrusion and a lower protrusion, and wherein a profiled inner surface of the lower beam comprises a plurality of shoulders, each shoulder being arranged to guide a respective one of the upper protrusion and the lower protrusion.

One embodiment comprises sliding bearings, each sliding bearing being provided between a respective shoulder and one of the upper or lower protrusions.

According to one embodiment the lower beam has at least one open slot to enable the pivot connection between the carrier unit and the main arm.

According to one embodiment the lower beam comprises at least one flexible curtain arranged to cover a respective one of the at least one open slot of the lower beam.

According to one embodiment each curtain is composed of silicone.

According to one embodiment the linear actuator is a screw type actuator comprising a rotatable screw, and wherein the carrier unit is configured to run along the lower beam.

According to one embodiment the linear actuator is arranged inside the lower beam.

According to one embodiment the lower beam has one of the following structures: is made in one piece and has a rectangular cross-sectional shape, is formed of two U-beams facing each other, or is formed of one U-beam.

There is according to a fifth aspect of the present disclosure provided a power wheelchair comprising the lift and tilt device of the fourth aspect.

Generally, all terms used in the claims are to be interpreted according to their ordinary meaning in the technical field, unless explicitly defined otherwise herein. All references to “a/an/the element, apparatus, component, means”, etc. are to be interpreted openly as referring to at least one instance of the element, apparatus, component, means, etc., unless explicitly stated otherwise.

### BRIEF DESCRIPTION OF THE DRAWINGS

The specific embodiments of the inventive concept will now be described, by way of example, with reference to the accompanying drawings, in which:

FIG. 1 shows a perspective view of an example of a lift and tilt device;

FIG. 2 shows a perspective view of the lift and tilt device with the upper and lower beams removed;

FIG. 3 shows the lift and tilt device in a folded state;

FIG. 4 shows the lift and tilt device in a lifted state;

FIG. 5 shows the lift and tilt device in a tilted state;

FIG. 6 shows another example of a lift and tilt device in a folded state;

FIG. 7 shows the lift and tilt device in FIG. 6 in a raised or elevated state;

FIG. 8 is a perspective view of an upper/lower beam of the lift and tilt device in FIG. 6;

FIG. 9 is a perspective view of the upper/lower beam, the first/second carrier unit, and side curtains, of the lift and tilt device in FIG. 6;

FIG. 10 is an end view of the arrangement shown in FIG. 9;

FIG. 11 depicts a power wheelchair comprising a lift and tilt device;

FIG. 12 shows a perspective view of an example of a tilt device;

FIG. 13 is a perspective view of an another example of an upper/lower beam; and

FIG. 14 shows a cross-section of the upper/lower beam in FIG. 13.

### DETAILED DESCRIPTION

The inventive concept will now be described more fully hereinafter with reference to the accompanying drawings, in which exemplifying embodiments are shown. The inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description.

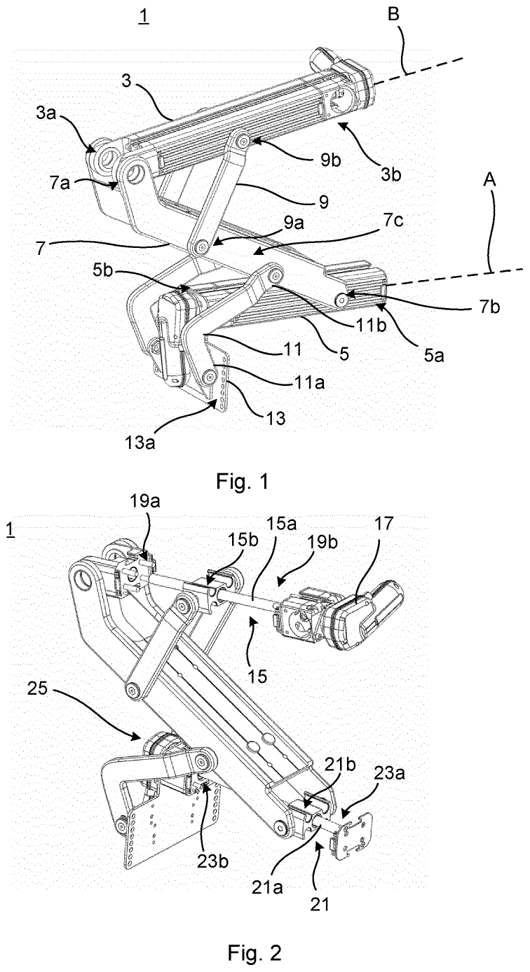

FIG. 1 depicts an example of a lift and tilt device 1. The lift and tilt device 1 is configured to be used with a power wheelchair to enable lifting and tilting of a seat of the power wheelchair. In FIG. 1, the lift and tilt device 1 is set in a somewhat raised and slightly forward or anterior tilted state.

The lift and tilt device 1 comprises an upper beam 3 and a lower beam 5. The upper beam 3 and the lower beam 5 may for example be extruded metal beams. The metal may for example be aluminium or an aluminium alloy, or a composite material. Other materials, including but not limited to polymers, are also being contemplated.

The lift and tilt device 1 comprises a main arm 7 extending between the upper beam 3 and the lower beam 5.

The upper beam 3 has a proximal end 3a and a distal end 3b. The main arm 7 is pivotally connected to the upper beam 3. The main arm 7 may have a first main arm end 7a pivotally connected to the proximal end 3a of the upper beam 3.

The lower beam 5 has a first end 5a and a second end 5b. The first end 5a and the second end 5b are opposite axial ends of the lower beam 5.

The main arm 7 is arranged to move axially along a longitudinal axis A of the lower beam 5. The main arm 7 may have a second main arm end 7b arranged to move axially along the lower beam 5.

The first main arm end 7a of the main arm 7 may be arranged angled relative to a main body 7c of the main arm 7. The first main arm end 7a of the main arm 7 may be arranged angled upwards relative to the main body 7c.

The lift and tilt device 1 comprises an upper arm 9. The upper arm 9 is pivotally connected to the main arm 7. The upper arm 9 may have a first upper arm end 9a pivotally connected to the main arm 7.

The upper arm 9 is arranged to move axially along a longitudinal axis B of the upper beam 3. The upper arm 9 may have a second upper arm end 9b arranged to move axially along the upper beam 3.

The lift and tilt device 1 comprises a lower arm 11 and a mounting structure 13. The mounting structure 13 is configured to be mounted to a wheelchair chassis. The mounting structure 13 may be provided with screw or bolt holes 13 for assembling the mounting structure 13 with the wheelchair chassis. The mounting structure 13 may for example be a mounting plate.

If the mounting structure 13 is a mounting plate, the mounting plate may be arranged at a right angle, or angled, relative to the longitudinal axis A of the lower beam 5, or parallel with the longitudinal axis A.

The lower arm 11 is pivotally connected to the mounting structure 13. The lower arm 11 may have a first lower arm end 11a which is pivotally connected to the mounting structure 13.

The lower arm 11 is pivotally connected to the main arm 7. The lower arm 11 may have a second lower arm end 11b pivotally connected to the main arm 7.

The lower arm 11 may be angled. The lower arm 11 may for example have an L-shape or be essentially L-shaped. The lower arm 11 extends from the main arm 7 and may be angled towards the mounting structure 13.

The lift and tilt device 1 may comprise two upper arms 9 and two lower arms 11. The lift and tilt device 1 may also comprise two spaced apart main arms 7. The two upper arms 9 may be connected to a respective one of the main arms 7. The two lower arms 11 may be connected to a respective one of the main arms 7.

FIG. 2 shows a perspective view of the tilt and lift device 1 with the upper beam 3 and the lower beam 5 removed to expose internal components of the lift and tilt device 1.

The lift and tilt device 1 comprises a first linear actuator 15, which in the following will be exemplified by and referred to as a first screw type actuator 15. The first screw type actuator 15 is arranged in said upper beam 3. The first screw type actuator 15 comprises a first rotatable screw 15a extending coaxially with the longitudinal axis B of the upper beam 3. The first rotatable screw 15a may extend from the proximal end 3a to the distal end 3b of the upper beam 3.

The first screw type actuator 15 comprises a first carrier unit 15b. The first carrier unit 15b may for example be a sled or a carriage. The first carrier unit 15b is arranged to run along the first rotatable screw 15a when the first rotatable screw 15a is rotated. Thus, when the first rotatable screw 15a is rotated in a first direction, the first carrier unit 15b may be arranged to move towards the proximal end 3a and when the first rotatable screw 15a is rotated in a second direction, opposite to the first direction, the first carrier unit 15b may be arranged to move towards the distal end 3b. The first carrier unit 15b has a threaded interior. The threaded interior may for example be formed by an inner surface of a through-opening, it can be in the form of one or more nuts arranged fixed inside a main body of the first carrier unit, the nut(s) being arranged around the first rotatable screw 15a.

The first carrier unit 15b is configured to move between a distal position 19a and a proximal position 19b by rotation of the first rotatable screw 15a.

The first carrier unit 15b has a through-opening extending along the longitudinal axis B of the upper beam 3. The first rotatable screw 15a runs through the through-opening of the first carrier unit 15b. The through-opening may be provided with threads to enable interaction with the first rotatable screw 15a.

The lift and tilt device 1 comprises a first motor 17. The first motor 17 may be an electric motor. The first motor 17 is configured to drive the first rotatable screw 15a. The first motor 17 is thus configured to cause rotation of the first rotatable screw 15a in the first direction and in the second direction. The first motor 17 may for example be arranged at an end of the upper beam 3, such as at the distal end 3b.

The second upper arm end 9b of the upper arm 9 is connected to the first carrier unit 15b. The upper arm 9 is thus manoeuvred by movement of the first carrier unit 15b along the upper beam 3.

The lift and tilt device 1 comprises a second linear actuator 21, which in the following will be exemplified by and referred to as a second screw type actuator 21. The second screw type actuator 21 is arranged in the lower beam 5. The second screw type actuator 21 comprises a second rotatable screw 21a extending coaxially with the longitudinal axis A of the lower beam 5. The second rotatable screw 21a may extend from the first end 5a to the second end 5b of the lower beam 5.

The second screw type actuator 21 comprises a second carrier unit 21b. The second carrier unit 21b may for example be a sled or a carriage. The second carrier unit 21b is arranged to run along the second rotatable screw 21a when the second rotatable screw 21a is rotated. Thus, when the second rotatable screw 21a is rotated in one direction, the second carrier unit 21b may be arranged to move towards the first end 5a and when the second rotatable screw 21a is rotated in the other direction the second carrier unit 21b may be arranged to move towards the second end 5b.

The second carrier unit 21b is configured to move between a first position 23a and a second position 23b by rotation of the second rotatable screw 21a.

The second carrier unit 21b has a through-opening extending along the longitudinal axis A of the lower beam 5. The second rotatable screw 21a runs through the through-opening of the second carrier unit 21b. The through-opening may be provided with threads to enable interaction with the second rotatable screw 21a.

The lift and tilt device 1 comprises a second motor 25. The second motor 25 may be an electric motor. The second motor 25 is configured to drive the second rotatable screw 21a. The second motor 25 is thus configured to cause rotation of the second rotatable screw 21a in both rotational directions. The second motor 25 may for example be arranged at an end of the lower beam 5, such as at the second end 5b, or at the first end 5a.

The second main arm end 7b of the main arm 7 is connected to the second carrier unit 21b. The main arm 7 is thus manoeuvred by movement of the second carrier unit 21b along the lower beam 5.

The upper beam 3 may comprise a first inner support structure and the first carrier unit 15b may have a corresponding first engagement structure configured to engage with the first inner support structure to maintain the first carrier unit 15b in a fixed radial position relative to radial directions of the longitudinal axis B of the upper beam 3 and in a fixed tangential position relative to the longitudinal axis B. The first carrier unit 15b is thus rotationally locked relative to the upper beam 3.

According to one example, the first inner support structure may, in cross-section of the upper beam 3, be formed by a profiled inner surface of the upper beam 3. The first engagement structure may have an outer contour adapted to the shape of the profiled inner surface of the upper beam 3.

The lower beam 5 may comprise a second inner support structure and the second carrier unit 21b may have a corresponding second engagement structure configured to engage with the second inner support structure to maintain the second carrier unit 21b in a fixed radial position relative to radial directions of the longitudinal axis A of the lower beam 5 and in a fixed tangential position relative to the longitudinal axis A. The second carrier unit 21b is thus rotationally locked relative to the lower beam 5.

The second inner support structure may for example, in cross-section of the lower beam 5, be formed by a profiled inner surface of the lower beam 5. The second engagement structure may have an outer contour adapted to the shape of the profiled inner surface of the inner beam 5.

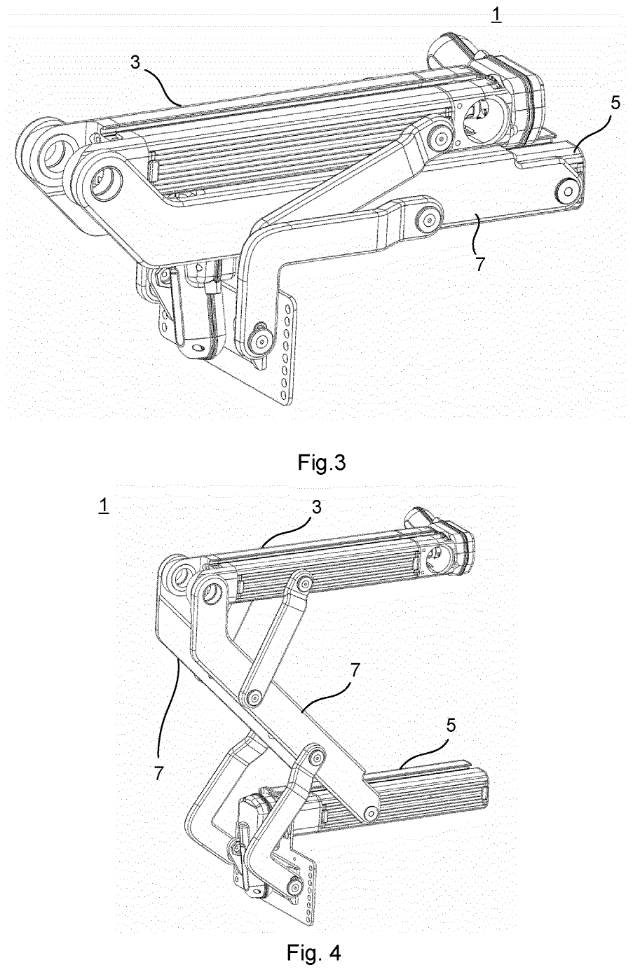

FIG. 3 depicts the lift and tilt device 1 in a folded state. In the folded state, the first carrier unit 15b is in the distal position 19b and the second carrier unit 21b is in the first position 23a. The upper beam 3 and the lower beam 5 are in this case arranged in parallel. Thus, the two longitudinal axes A and B are parallel with each other. In use, the upper beam 3 is arranged on top of the lower beam 5. Moreover, the main arm 7 is arranged in parallel with both the upper beam 3 and the lower beam 5. The main arm 7 may partly receive the lower beam 5, as illustrated in FIG. 3.

FIG. 4 shows the lift and tilt device 1 in a fully lifted, or elevated, state. The first carrier unit 15b is in this case in the present example closer to the proximal position 19a than to the distal position 19b, and the second carrier unit 21b is in the second position 23b. The upper beam 3 and the lower beam 5 are arranged parallel with each other. Thus, the longitudinal axes A and B are arranged in parallel when the lift and tilt device 1 is in the lifted state. By moving the first carrier unit 15b even closer to the proximal position 19a, the lift and tilt device 1 may be set in a pronounced forward tilted position, not shown in the figures. Thereby, when the upper beam is in a pronounced forward tilted position, e.g., at 45-90 degrees to the horizontal plane, a seat attached to the upper beam may be positioned in a close to vertical orientation, resulting in an essentially standing position of a user. The lift and tilt device 1 may be set in lifted or elevated states that are lower than the fully lifted state depicted in FIG. 4, by setting the first carrier unit 15b and the second carrier unit 21b in appropriate positions along the upper beam 3 and the lower beam 5, respectively.

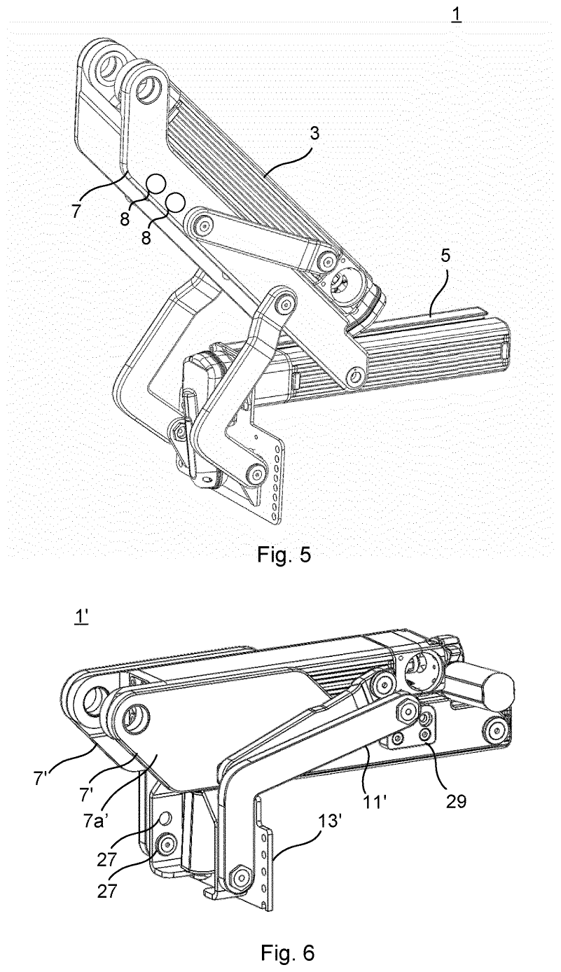

In FIG. 5 the lift and tilt device 1 is shown in a rearward tilted state. The rearward tilted state provides a posterior tilt function when the lift and tilt device 1 has been mounted to a wheelchair chassis.

In the tilted state, the first carrier unit 15a is in the distal position 19b and the second carrier unit 21b is in the second position 23b. In this case, the upper beam 3 is angled relative to the lower beam 5. The longitudinal axis B of the upper beam 3 and the longitudinal axis A of the lower beam 5 are in this case contained in a respective plane that intersect each other. The main arm 7 is arranged parallel with the upper beam 3.

In production, one of several openings 8 that may be present in the main arm 7 may be selected for attaching the upper arm 7 to the main arm 7. The length of upper arm 7 used may thus during manufacturing be selected based on the location of the opening 8 to which it is to be attached to. The opening 8 that is selected is based on e.g., the weight and size of the user. The openings 8 may or may not be present in any of the examples disclosed herein.

FIG. 6 shows another example of a lift and tilt device. The lift and tilt device 1′ is similar to the lift and tilt device 1 described above. The arms, such as the main arm(s) 7′ and the lower arm 11′ are however somewhat different in design. For example, the main arms 7′ have a wider first main arm end 7a′. Moreover, the support structure 13′ has several sets of two openings 27 for attaching the lower arms 11′ to the support structure 13′. In production, several sizes of the lower arms 11′ may be selected for the lift and tilt device 1′ that is being built based on e.g., the weight and size of the user, and the suitable set of openings 27 may be used for attaching the lower arms 11′ to the support structure 13′. Further, the lift and tilt device 1′ may comprise an adapter plate 29 attached to the main arm 7. The adapter plate 29 provides several sets of openings for attaching the lower arm 11′ to the main arm 7′, based on e.g., the size and weight of the user.

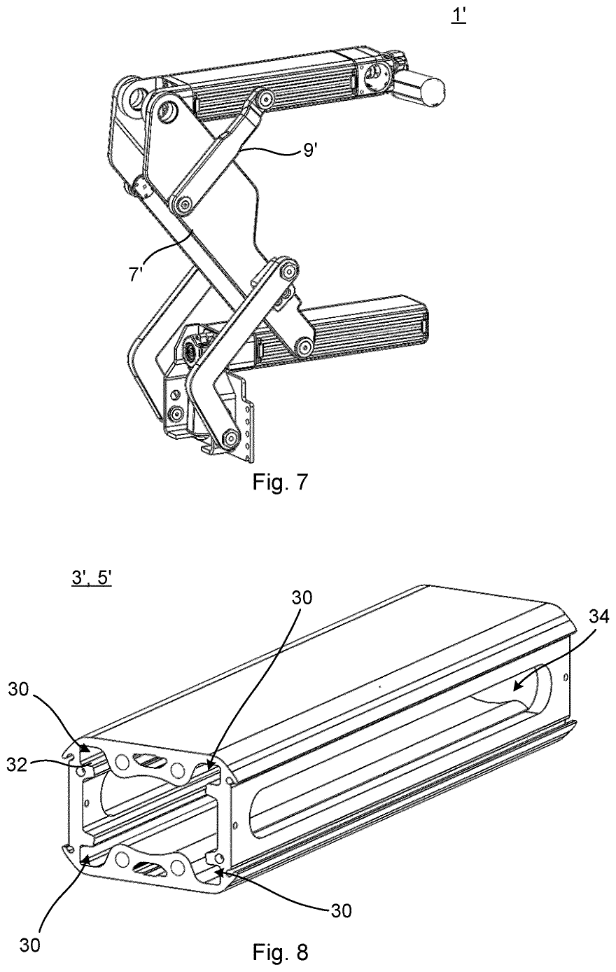

FIG. 7 depicts the lift and tilt device 1′ in the fully lifted, or elevated, state. Both lift and tilt devices 1, 1′ may be provided with several openings in the main arm 7, 7′ for attaching the upper arm 9′ to the main arm 7, 7′. The position of the opening(s) selected for attaching the upper arm 9, 9′ to the main arm 7, 7′ determines the force and/or speed with which the upper arm 9, 9′ is able to move when the lift and tilt device 1, 1′ changes state. The selection of the position may be based on the size and/or weight of the user.

FIG. 8 shows an example of one of the upper beam 3′ and the lower beam 5′ of the lift and tilt device 1′. The beam 3′, 5′ may be an extruded metal profile, for example made of aluminium or an aluminium alloy, or a composite material. Other materials, including but not limited to polymers, are also being contemplated. During production, the length of the beam 3′, 5′ may be selected based on the size of the intended user. There may for example be a number of predetermined lengths to which the beam 3′, 5′ may be cut in the factory, based on the size of the intended user.

The beam 3′, 5′ is hollow and has a profiled inner surface. The profiled inner surface is provided with four axially extending grooves 30. In cross-section of the beam 3′, 5′, the grooves 30 may be arranged in a respective corner of the profiled inner surface. Other variations are also envisaged; for example two grooves may be centred at an upper side and a lower side, and two grooves may be arranged at a respective lateral side of the beam 3′, 5′. There could according to some examples be less than four grooves, for example three grooves, or more than four grooves. Each groove 30 has a planar support surface 32.

The beam 3′, 5′ has an outer surface provided with at least one open slot 34 that extends through the wall of the beam 3′, 5′ and opens into the interior of the beam 3′, 5′. The slot 34 extends along the longitudinal axis of the beam 3′, 5′. According to one example, the beam 3′, 5′ has two slots 34, arranged at a respective lateral side of the beam 3′, 5′. Alternatively, the beam 3′, 5′ could be provided with two slots at opposite lower and upper sides, or a single slot arranged at a lower side, or an upper side, of the beam 3′, 5′, for example.

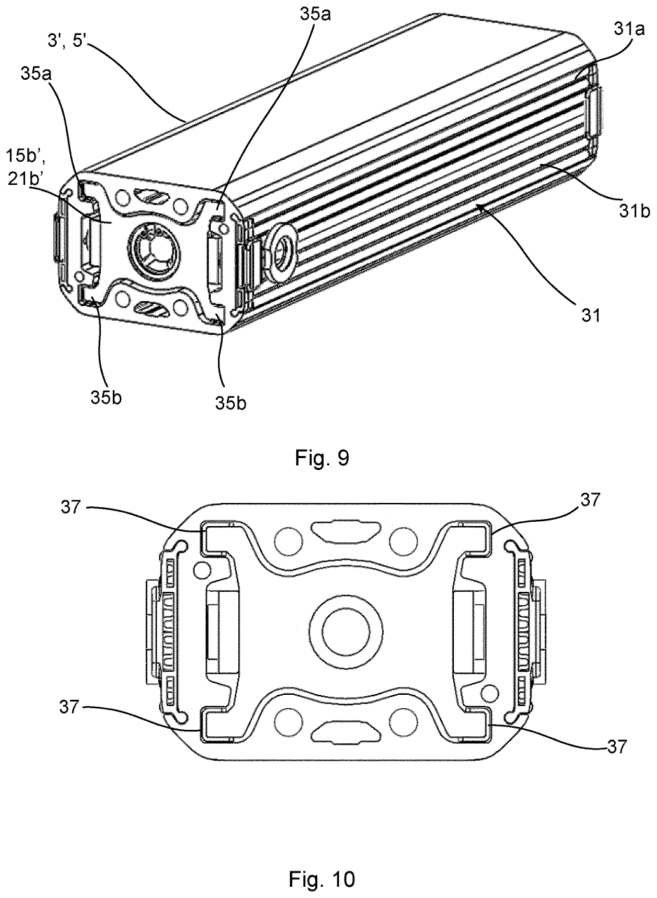

FIG. 9 depicts the beam 3′, 5′ with the corresponding first/second carrier unit 15b′, 21b′ arranged inside the beam 3′, 5′. The carrier unit 15b′, 21b′ has an outer contour adapted to the shape of the profiled inner surface of the beam 3′, 5′, e.g., in accordance with said variations in the shape of the beam inner surface as described above.

The carrier unit 15b′, 21b′ comprises a plurality of protrusions 35a-35b. According to the example in FIG. 9, the protrusions 35a-35b are two upper lateral protrusions, or upper wings, 35a and two lower lateral protrusions, or lower wings, 35b. The upper lateral protrusions 35a extend towards opposite sides of the beam 3′, 5′. The lower lateral protrusions 35b extend towards opposite sides of the beam 3′, 5′.

The two upper lateral protrusions 35a are arranged to run in a respective one of the two upper grooves 30 and rest on a respective support surface 32 of these grooves 30. The two lower lateral protrusions 35b are arranged to run in a respective one of the two lower grooves 30 and rest on a respective support surface 32 of the two lower grooves 30.

The carrier unit 15b′, 21b′ comprises a plurality of sliding bearing 37, as shown in FIG. 10, which is a cross sectional view of the beam 3′, 5′. Each sliding bearing 37 is arranged between a respective lateral protrusion 35a, 35b and a support surface 32 to facilitate axial movement of the carrier unit 15b′, 21b′ relative to the beam 3′, 5′.

The sliding bearings 37 may for example be attached to the carrier unit 15b′, 21b′ by means of protrusions in the sliding bearings 37 that extend into corresponding openings of the lateral protrusions 35a, 35b.

Returning now to FIG. 9, the beam 3′, 5′ comprises one or more flexible curtains 31. Each curtain 31 is arranged to cover a respective one of the open slots 34 shown in FIG. 8. Each curtain 31 may comprise a first curtain member 31a and a second curtain member 31b extending in parallel along the open slot 34. The first and second curtain members 31a, 31b directly contact each other and are arranged to close the open slot 34, thus protecting the interior of the beam 3′, 5′ from dirt and dust. The upper arm 9′ and the lower arm 11′ are connected to the carrier unit 15b′, 21b′ through the slot 34. The first and the second curtain members 31a, 31b thus become separated at the position of connection between the carrier unit 15b′, 21b′ and the upper arm 9′, 11′ along the length of the beam 3′, 5′, but are in contact everywhere else along the extension of the curtain 31. It is to be noted that the example disclosed in FIGS. 1-5 also has the same solution with the curtain 31. Each curtain 31 may for example be composed of silicone.

FIG. 11 schematically shows an example of a power wheelchair 39 comprising the lift and tilt device 1, 1′. The lift and tilt device 1, 1′ is highlighted or emphasised with more pronounced contours than the rest of the power wheelchair 39 to illustrate its position.

While the exemplified power wheelchair is a front wheel drive wheelchair, it could alternatively be of any other drive configuration, such as a mid-wheel drive or a rear-wheel-drive wheelchair.

The power wheelchair 39 comprises a wheelchair chassis 41. The lift and tilt device 1, 1′ is mounted to the wheelchair chassis 41. The mounting structure 13, 13′ may for example be mounted to a front portion, or an upper portion, of the chassis 41. In the disclosed embodiments, the beams 3, 3′, 5, 5′ are arranged on top of the wheelchair chassis 41. Alternatively, the lower beam 5 5′ can be integrated into the chassis, or arranged fully or partly inserted into the upper portion of the chassis. The mounting structure 13, 13′ may according to one example be integrated with the chassis.

The power wheelchair 39 also comprises a seat 43. The seat 43 is mounted to the lift and tilt device 1, 1′ such that when the lift and tilt device 1, 1′ is actuated between different states, the position of the seat 43 is changed correspondingly. The seat 43 may thus be raised/elevated and tilted backwards or forward based on the state of the lift and tilt device 1, 1′.

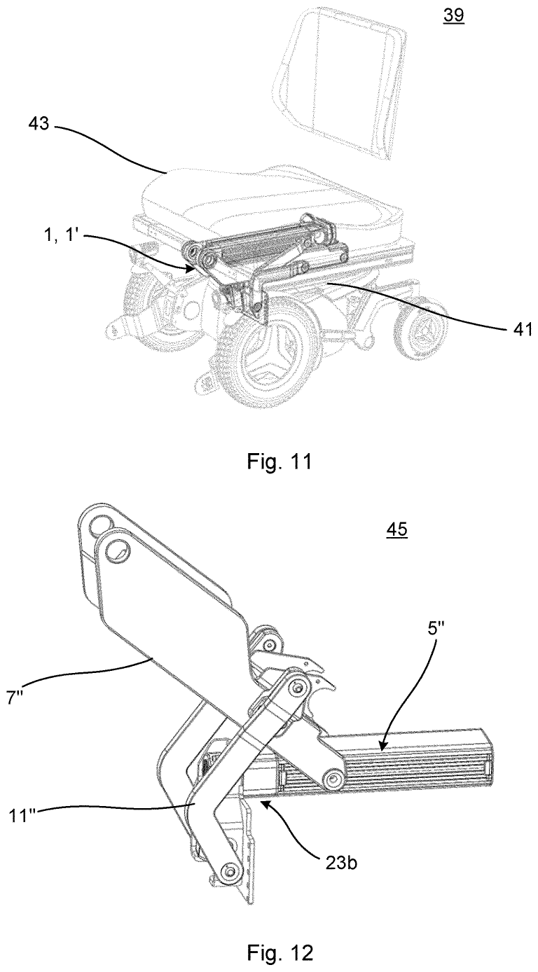

FIG. 12 shows an example of a tilt device 45 for a power wheelchair. The tilt device 45 is similar to the lift and tilt devices 1, 1′ previously described, but only comprises a single beam, i.e., the lower beam 5″, and no upper arm. The tilt device 45 only provides tilt functionality. As the main arm 7″ is moved along the lower beam 5″ towards the second position 23b, the main arm 7″ is tilted as shown in FIG. 12. When the tilt device 45 is installed in a power wheelchair, this results in tilting of the seat. When the main arm 7″ is moved to the opposite position along the lower beam 5″, the main arm 7″ is set parallel with the longitudinal axis of the lower beam 5″. When the tilt device 45 is installed in a power wheelchair, this results in a flat/horizontal position of the seat.

The upper and/or lower beam may instead of having circumferentially closed portions as exemplified in the figures, have a U-shape, be formed of two U-shaped beam members facing each other, have an L-shape, or an I-shape, for example.

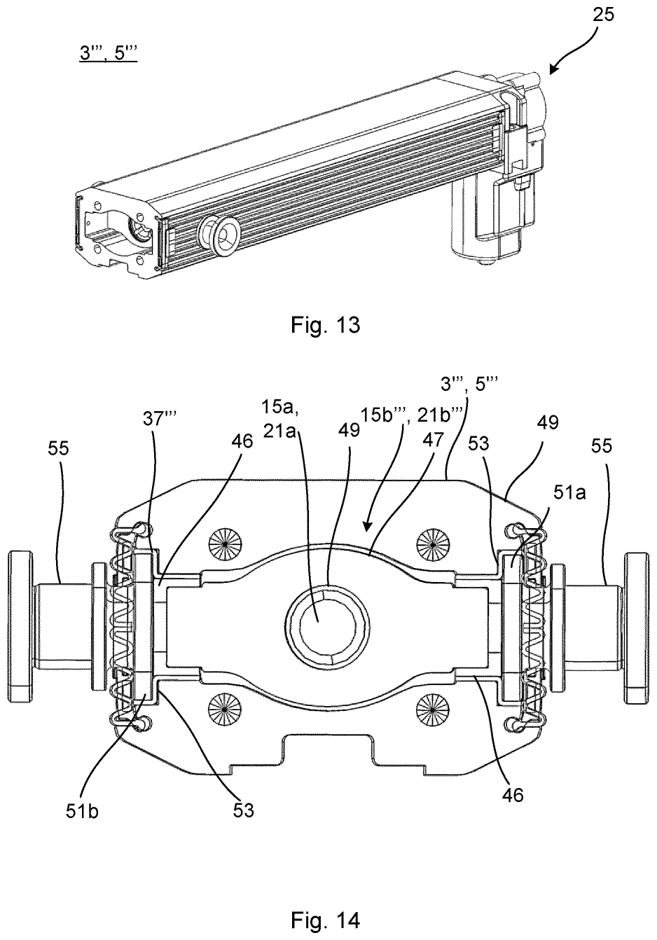

FIG. 13 shows a perspective view of another example of an upper beam/lower beam 3′″, 5′″ similar to the previously described beams. The upper/lower beam 3′″, 5′″ may be included in the tilt and lift device according to any example described herein. The beam 3′″, 5′″ may be an extruded metal profile, for example made of aluminium or an aluminium alloy, or a composite material. Other materials, including but not limited to polymers, are also being contemplated.

The beam 3′″, 5′″ is hollow and has a profiled inner surface.

Turning to FIG. 14, the carrier unit 15b′″, 21b′″ comprises a carrier unit body 47, and two lateral wing members 46. The carrier unit body 47 may have a through-opening 49 in the longitudinal axial direction of the beam 3′″, 5′″. The through-opening 49 is configured to receive the first/second rotatable screw 15a, 21a. The inner surface of the through-opening 49 is arranged to cooperate with the first/second rotatable screw 15a, 21a such that when the first/second rotatable screw 15a, 21a is rotated, the carrier unit 15b′″, 21b′″ is moved along the beam 3′″, 5′″.

Each lateral wing member 46 is attached to the carrier unit body 47. In cross-section of the carrier unit 15b′″, 21b′″ the lateral wing members 46 may be attached to a respective side of the carrier unit body 47. The lateral wing members 46 may for example be attached to the carrier unit body 47 by means of screws, bolts, press-fitting, and/or welding. Alternatively, the lateral wing members and the central carrier body may be formed in one piece, i.e., the lateral wing members and the central carrier body may form an integral body.

Each lateral wing member 46 may comprise an upper protrusion, or upper flange, 51a and a lower protrusion, or lower flange, 51b.

The profiled inner surface of the beam 3′″, 5′″ comprises a plurality of shoulders 53 each being arranged to guide a respective protrusion 51a, 51b. The number of shoulders 53 may be equal to the number of protrusions 51a, 51b. Each protrusion 51a, 51b is arranged to slide along a respective one of the shoulders 53.

This configuration with the carrier unit 15b′″, 21b′″ being assembled of several components instead of being integrated, and with the beam 3′″, 5′″ having shoulders 53 instead of grooves, facilitates production and assembly of the beam 3′″, 5′″ with the carrier units 15b′″, 21b′″ with respect to manufacturing tolerances.

A sliding bearing 37′″ may be provided between each shoulder 53 and the respective protrusion 51a, 51b. Each sliding bearing 37′″ is arranged between a respective protrusion 51a, 51b and a shoulder 53 to facilitate longitudinal axial movement of the carrier unit 15b′″, 21b′″ along the beam 3′″, 5′″.

The carrier unit 15b′″, 21b′″ may be provided with mounting member 55. Each mounting member 55 may extend from a respective one of the lateral wing members 46 through a respective open slot of the beam 3′″, 5′″. The second upper arm end 9b of each upper arm 9 may be pivotally connected to a respective one of the mounting members 55.

In variations of any example of the upper beam 3, 3′,3′″ disclosed herein, the beam 3, 3′,3′″ may instead of having two lateral open slots, i.e., at a respective lateral side of the beam 3, 3′,3′″, have two open slots arranged underneath the beam 3, 3′,3′″ for connecting two upper arms 9 with the carrier unit 15b, 15b′, 15b′″ or there may be a single slot underneath the beam 3, 3′,3′″ to connect a single upper arm 9 with the carrier unit 15b, 15b′, 15b′″. The inventive concept has mainly been described above with reference to a few examples. However, as is readily appreciated by a person skilled in the art, other embodiments than the ones disclosed above are equally possible within the scope of the inventive concept, as defined by the appended claims.

1. A lift and tilt device (1; 1′) for manoeuvring a seat (43) of a power wheelchair (39), comprising:
an upper beam (3; 3′; 3′″) having a proximal end (3a) and a distal end (3b),
a first linear actuator (15) arranged along the upper beam (3; 3′; 3′″) comprising a first carrier unit (15b; 15b′; 15′″) configured to run along the upper beam (3; 3′; 3′″) from a distal position (19b) towards the proximal end (3a) to a proximal position (19a), and from the proximal position (19a) to the distal position (19b),
a lower beam (5; 5′; 5′″),
a second linear actuator (21) arranged along the lower beam (5; 5′; 5′″) comprising a second carrier unit (21b; 21b′; 21b′″) configured to run along the lower beam (5; 5′; 5′″) between a first position (23a) and a second position (23b),
a main arm (7; 7′) pivotally connected to the proximal end (3a) of the upper beam (3; 3′; 3′″) and to the second carrier unit (21b; 21b′; 21b′″),
an upper arm (9; 9′) pivotally connected to the main arm (7; 7′) and to the first carrier unit (21b; 21b′; 21b′″),
a mounting structure (13; 13′) fixedly arranged relative to the lower beam (5; 5′), and
a lower arm (11; 11′) pivotally connected to the main arm (7; 7′) and to the mounting structure (13; 13′).

2. A lift and tilt device (1; 1′) as claimed in claim 1, wherein when the first carrier unit (15b; 15b′; 15b′″) is in the distal position (19b) and the second carrier unit (21b; 21b′; 21b′″) is in the first position (23a), the lift and tilt device (1; 1′) is in a folded state, wherein when the first carrier unit (15b; 15b′; 15b′″) is located closer to the proximal position (19a) than in the folded state, and the second carrier unit (21b; 21b′; 21b′″) is closer to the second position (23b) than in the folded state, the lift and tilt device (1; 1′) is in a lifted state.

3. (canceled)

4. (canceled)

5. (canceled)

6. The lift and tilt device (1; 1′) as claimed in claim 2, wherein the mounting structure (13; 13′) is connected to a second end (5b) of the lower beam (5; 5′; 5′″), wherein the second carrier unit (21b; 21b′; 21b′″) is configured to run along the lower beam (5; 5′; 5′″) from the first position (23a) towards the second end (5b) to reach the second position (23b).

7. The lift and tilt device (1; 1′) as claimed in claim 1, wherein when the first carrier unit (15b; 15b′; 15b′″) is in the distal position (19b) and the second carrier unit (21b; 21′b; 21b′″) is in the second position (23b), the lift and tilt device (1; 1′) is in a tilted state.

8. The lift and tilt device (1; 1′) as claimed in claim 1, further comprising a first electric motor (17) configured to drive the first linear actuator (15a), and a second electric motor (25) configured to drive the second linear actuator (21a).

9. (canceled)

10. The lift and tilt device (1; 1′) as claimed in claim 1, wherein the upper beam (3; 3′; 3′″) and the lower beam (5; 5′; 5′″) are contained in a median plane of the lift and tilt device (1; 1′).

11. The lift and tilt device (1′) as claimed in claim 1, wherein in cross-section each of the first and the second carrier unit (1b′, 21b′) comprises a plurality of protrusions (35a-35b) along their perimeter, and wherein each of the upper and lower beam (3′, 5′) has a plurality of planar support surfaces (32) configured to support a respective one of the protrusions (35a-35b) of one of the first and the second carrier units (1b′, 21b′), and a plurality of sliding bearings (37), each sliding bearing (37) being arranged between a respective protrusion (35a-35b) and support surface (32) to facilitate axial movement of the first and second carrier unit (15b′, 21b′) relative to the respective beam (3′, 5′).

12. The lift and tilt device (1′) as claimed in claim 11, wherein for each of the first and the second carrier unit (1b′, 21b′) the protrusions (35a-35b) are two upper lateral protrusions (35a) and two lower lateral protrusions (35b), and wherein each of the upper and lower beam (3′, 5′) has four planar support surfaces (32) configured to support a respective one of the lateral protrusions (35a, 35b), wherein each support surface (32) forms part of a respective groove (30) in the upper and lower beam (3′, 5′), in which the respective lateral protrusion (35a, 35) is configured to run.

13. (canceled)

14. The lift and tilt device as claimed in claim 1, wherein each of the first and the second carrier unit (15b′″, 21b′″) comprises a carrier unit body (47), and two lateral wing members (46), wherein each lateral wing member (46) is attached to a respective side of the carrier unit body (47).

15. The lift and tilt device as claimed in claim 14, wherein each lateral wing member (46) comprises an upper protrusion (51a) and a lower protrusion (51b), and wherein a profiled inner surface of the upper beam (3′″) and the lower beam (5′″) comprises a plurality of shoulders (53), each shoulder (53) being arranged to guide a respective one of the upper protrusion (51a) and the lower protrusion (51b).

16. The lift and tilt device as claimed in claim 15, comprising sliding bearings (37′″), each sliding bearing (37′″) being provided between a respective shoulder (53) and one of the upper or lower protrusions (51a, 51b).

17. The lift and tilt device (1′) as claimed in claim 1, wherein the upper beam (3′; 3′″) has at least one open slot (34) to enable the pivot connection between the first carrier unit (15b′; 15b′″) and the upper arm (9′), and the lower beam (5′; 5′″) has at least one open slot (34) to enable the pivot connection between the second carrier unit (21′b; 21b′″) and the main arm (7′).

18. The lift and tilt device (1′) as claimed in claim 14, wherein the upper beam (3′; 3′″) comprises at least one flexible (31) curtain arranged to cover a respective one of the at least one open slot (34) of the upper beam (3′; 3′″), and the lower beam (5′; 5′″) comprises at least one flexible curtain (31) arranged to cover a respective one of the at least one open slot (34) of the lower beam (5′; 5′″).

19. (canceled)

20. The lift and tilt device (1; 1′) as claimed in claim 1, wherein the first linear actuator (15) is a first screw type actuator comprising a first rotatable screw (15a), wherein the first carrier unit (15b; 15b′; 15b′″) is configured to run along the upper beam (3; 3′; 3′″), wherein the second linear actuator (21) is a second screw type actuator comprising a second rotatable screw (21b), and wherein the second carrier unit (21b; 21b′; 21b′″) is configured to run along the lower beam (5; 5′; 5′″).

21. The lift and tilt device (1; 1′) as claimed in claim 1, wherein the first linear actuator (15) is arranged inside the upper beam (3; 3′; 3′″), and the second linear actuator (21) is arranged inside the lower beam (5; 5′; 5′″).

22. The lift and tilt device (1; 1′) as claimed in claim 1, wherein each of the upper beam (3; 3′; 3′″) and the lower beam (5; 5′; 5′″) has one of the following structures: is made in one piece and has a rectangular cross-sectional shape, is formed of two U-beams facing each other, or is formed of one U-beam.

23. A power wheelchair (39) comprising the lift and tilt device (1; 1′) as claimed in claim 1.

24. (canceled)

25. A lift and tilt device (45) for manoeuvring a seat (43) of a power wheelchair (39), comprising:
a lower beam (5″),
a linear actuator arranged along the lower beam (5″) comprising a carrier unit configured to run along the lower beam (5″) between a first position and a second position,
a main arm (7″) pivotally connected to the carrier unit,
a mounting structure fixedly arranged relative to the lower beam (5″), and
a lower arm (11″) pivotally connected to the main arm (7″) and to the mounting structure,
wherein the lower beam (5″) has at least one open slot (34) to enable the pivot connection between the carrier unit (21′b) and the main arm (7″).

26. The lift and tilt device (45) as claimed in claim 25, comprising an electric motor (25) configured to drive the linear actuator.

27. (canceled)

28. The lift and tilt device (45) as claimed in claim 25, wherein the lower beam (5″) is contained in a median plane of the lift and tilt device (45).

29. The lift and tilt device (45) as claimed in claim 25, wherein in cross-section the carrier unit (21b′) comprises a plurality of protrusions (35a-35b) along their perimeter, and wherein the lower beam (5″) has a plurality of planar support surfaces (32) configured to support a respective one of the protrusions (35a-35b) of the carrier units (21b′), and a plurality of sliding bearings (37), each sliding bearing (37) being arranged between a respective protrusion (35a-35b) and support surface (32) to facilitate axial movement of the carrier unit (21b′) relative to the lower beam (5″).

30. The lift and tilt device (45) as claimed in claim 29 wherein the protrusions (35a-35b) are two upper lateral protrusions (35a) and two lower lateral protrusions (35b), and wherein the lower beam (5″) has four planar support surfaces (32) configured to support a respective one of the lateral protrusions (35a, 35b), wherein each support surface (32) forms part of a respective groove (30) in the lower beam (5″), in which the respective lateral protrusion (35a, 35) is configured to run.

31. (canceled)

32. The lift and tilt device (45) as claimed claim 25, wherein the carrier unit (21b′″) comprises a carrier unit body (47), and two lateral wing members (46), wherein each lateral wing member (46) is attached to a respective side of the carrier unit body (47), wherein each lateral wing member (46) comprises an upper protrusion (51a) and a lower protrusion (51b), and wherein a profiled inner surface of the lower beam (5′″) comprises a plurality of shoulders (53), each shoulder (53) being arranged to guide a respective one of the upper protrusion (51a) and the lower protrusion (51b).

33. (canceled)

34. The lift and tilt device (45) as claimed in claim 32, comprising sliding bearings (37′″), each sliding bearing (37′″) being provided between a respective shoulder (53) and one of the upper or lower protrusions (51a, 51b).

35. The lift and tilt device (45) as claimed in claim 25, wherein the lower beam (5″) comprises at least one flexible curtain (31) arranged to cover a respective one of the at least one open slot (34) of the lower beam (5′).

36. (canceled)

37. The lift and tilt device (45) as claimed in claim 25, wherein the linear actuator is a screw type actuator comprising a rotatable screw, and wherein the carrier unit is configured to run along the lower beam (5″), and wherein the linear actuator is arranged inside the lower beam (5″).

38. (canceled)

39. The lift and tilt device (45) as claimed in claim 25, wherein the lower beam has one of the following structures: is made in one piece and has a rectangular cross-sectional shape, is formed of two U-beams facing each other, or is formed of one U-beam.

40. A power wheelchair (39) comprising the lift and tilt device (45) as claimed in claim 25.
